(19) United States
(12) Patent Application Publication
(10) Pub. No.: US 2013/0129226 A1
(43) Pub. Date: May 23, 2013

(54) IMAGE PROCESSING APPARATUS AND IMAGE PROCESSING PROGRAM

(71) Applicant: Hiroyuki Abe, Yokohama-shi (JP)

(72) Inventor: Hiroyuki Abe, Yokohama-shi (JP)

(73) Assignee: NIKON CORPORATION, Tokyo (JP)

(21) Appl. No.: 13/812,418

(22) PCT Filed: Jul. 27, 2011
(86) PCT No.: PCT/JP2011/067145

§ 371 Date: Jan. 25, 2013

(30) Foreign Application Priority Data
Jul. 29, 2010 (JP) 2010-170035

(51) Int. Cl. G06K 9/46

(52) U.S. Cl. CPC G06K 9/46
USPC 382/199

(57) ABSTRACT

An image processing apparatus includes: an edge image generation device that generates an edge image by extracting edges in an image; a matching device that executes template matching operation for the edge image having been generated by the edge image generation device by using a template expressing a fixed pattern having a predetermined shape; an evaluation value calculation device that calculates, based upon matching results provided by the matching device, an evaluation value to be used to determine a position of the fixed pattern having the predetermined shape within the image; and a specifying device that specifies the position taken by the fixed pattern having the predetermined shape within the image based upon the evaluation value calculated by the evaluation value calculation device.

### TECHNICAL FIELD

The present invention relates to an image processing apparatus and an image processing program.

### BACKGROUND ART

The pattern matching methods known in the related art include the following. In this particular pattern matching method, an image is divided into a plurality of areas, template matching processing is executed for each area and the area achieving the highest level of similarity is extracted as a matching area (patent literature 1).

### CITATION LIST

### Patent Literature

PATENT LITERATURE 1: Japanese Laid Open Patent Publication No. H5-81433

### SUMMARY OF INVENTION

### Technical Problem

However, the template matching processing executed in the method in the related art gives rise to an issue in that if the target image is unclear, a subject position within the image may not be determined accurately.

### Solution to Problem

An image processing apparatus according to a first aspect of the present invention comprises: an edge image generation device that generates an edge image by extracting edges in an image; a matching device that executes template matching operation for the edge image having been generated by the edge image generation device by using a template expressing a fixed pattern having a predetermined shape; an evaluation value calculation device that calculates, based upon matching results provided by the matching device, an evaluation value to be used to determine a position of the fixed pattern having the predetermined shape within the image; and a specifying device that specifies the position taken by the fixed pattern having the predetermined shape within the image based upon the evaluation value calculated by the evaluation value calculation device.

According to a second aspect of the present invention, in the image processing apparatus according to the first aspect, it is preferable that the evaluation value calculation device calculates the evaluation value at each template position taken by the template as the template is sequentially shifted within the image by multiplying a pixel value indicated at each pixel expressing the template by a pixel value indicated at a corresponding pixel in the edge image occupying a position matching the position of the pixel expressing the template and then by calculating a grand total of the multiplication results corresponding to all pixels expressing the template or by calculating a product of the multiplication results corresponding to all the pixels expressing the template used as multipliers.

According to a third aspect of the present invention, in the image processing apparatus according to the second aspect, it is preferable that the specifying device specifies a position taken by the template at which a largest evaluation value is calculated as the position taken within the image by the fixed pattern having the predetermined shape.

According to a fourth aspect of the present invention, in the image processing apparatus according to the first to third aspects, the fixed pattern having the predetermined shape may represent an AF area set within a photographic image plane at the camera.

An image processing program executed by a computer according to a fifth aspect of the present invention comprises; an edge image generation step in which an edge image is generated by extracting edges within an image; a matching step in which template matching operation is executed for the edge image having been generated through the edge image generation step by using a template expressing a fixed pattern having a predetermined shape; an evaluation value calculation step in which an evaluation value, to be used to determine a position taken by the fixed pattern having the predetermined shape within the image, is calculated based upon matching results obtained through the matching step; and a specifying step in which the position taken by the fixed pattern having the predetermined shape within the image is specified based upon the evaluation value having been calculated through the evaluation value calculation step.

### Advantageous Effect of Invention

According to the present invention, the position of a fixed pattern within an image can be determined accurately.

### BRIEF DESCRIPTION OF DRAWINGS

FIG. 1 is a block diagram showing the structure adopted in a camera achieved in an embodiment.

FIG. 2 shows how AF frames may be displayed within the photographic image plane.

FIG. 3 shows how a face detection frame may be displayed.

FIG. 4 shows how a characteristic facial feature and an AF frame may overlap in a specific example.

FIGS. 5(a) through 5(c) schematically illustrate a method that may be adopted when erasing an AF frame by using adjacent pixels.

FIG. 6 shows face detection results obtained after AF frame erasure.

FIG. 7 presents a specific example of an unclear image.

FIGS. 8(a) through 8(e) show how a detection area may be set in a specific example.

FIG. 9 presents a specific example of an edge image.

FIG. 10 presents a specific example of a template.

FIG. 11 shows how an image processing program may be provided via a recording medium or as a data signal via the Internet or the like.

### DESCRIPTION OF EMBODIMENTS

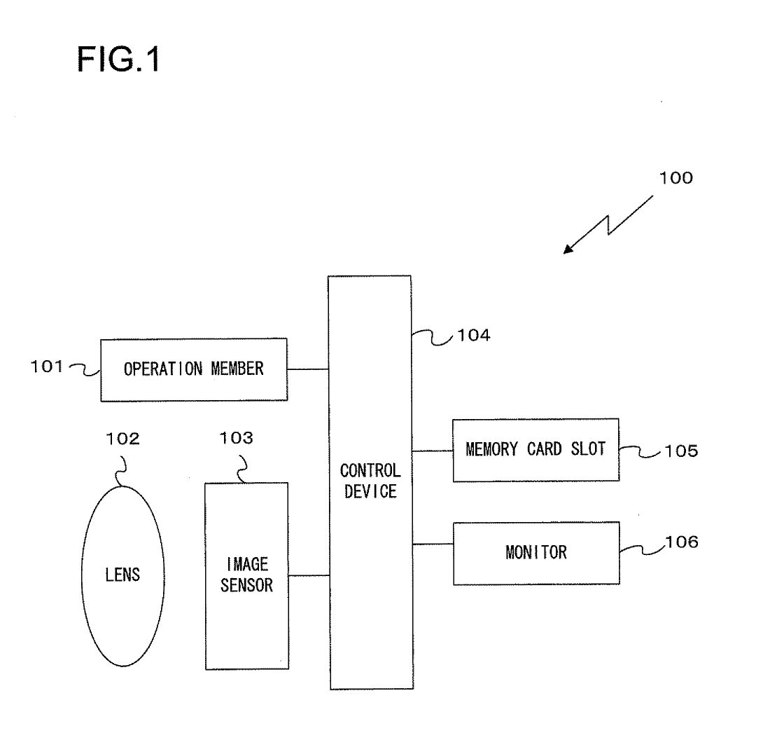

FIG. 1 is a block diagram showing the structure of a camera achieved in an embodiment by adopting the image processing apparatus according to the present invention. A camera 100 comprises an operation member 101, a lens 102, an image sensor 103, a control device 104, a memory card slot 105 and a monitor 106. The operation member 101 includes various input members operated by the user, such as a power button, a shutter release button, a zoom button, a cross key, a confirm button, a review button and a delete button.

While the lens 102 is constituted with a plurality of optical lenses, FIG. 1 simply shows a single representative lens. The image sensor 103, which may be a CCD image sensor or a CMOS image sensor, captures a subject image formed through the lens 102. The image sensor 103 outputs image signals obtained by capturing the image to the control device 104.

The control device 104 generates image data in a predetermined image format such as the JPEG format (hereafter referred to as “main image data”) based upon the image signals input thereto from the image sensor 103. In addition, the control device 104 generates display image data, e.g., thumbnail image data, based upon the image data having been generated. The control device 104 creates an image file that contains the main image data and the thumbnail image data having been generated and is appended with header information. The image file thus created is output to the memory card slot 105. The embodiment is described by assuming that the main image data and the thumbnail image data are both image data expressed in the RGB colorimetric system.

At the memory card slot 105, in which a memory card, used as a storage medium, is inserted, the image file output from the control device 104 is recorded as the image file is written into the memory card. In addition, in response to an instruction issued from the control device 104, an image file stored in the memory card is read at the memory card slot 105.

At the monitor 106, which is a liquid crystal monitor (back-side monitor) installed at the rear surface of the camera 100, an image stored in the memory card, a setting menu enabling selection of settings for the camera 100 and the like are displayed. In addition, as the user sets the camera 100 in a photographing mode, the control device 104 outputs to the monitor 106 display image data corresponding to images obtained from the image sensor 103 in time series. As a result, a live-view image corresponding to the display image data is displayed at the monitor 106.

The control device 104, constituted with a CPU, a memory and other peripheral circuits, controls the camera 100. It is to be noted that the memory constituting part of the control device 104 includes an SDRAM and a flash memory. The SDRAM, which is a volatile memory, is used as a work memory where a program executed by the CPU is opened and as a buffer memory where data are temporarily recorded by the CPU. In addition, in the flash memory, which is a non-volatile memory, program data related to the program executed by the control device 104, various parameters that are read for program execution and the like are recorded.

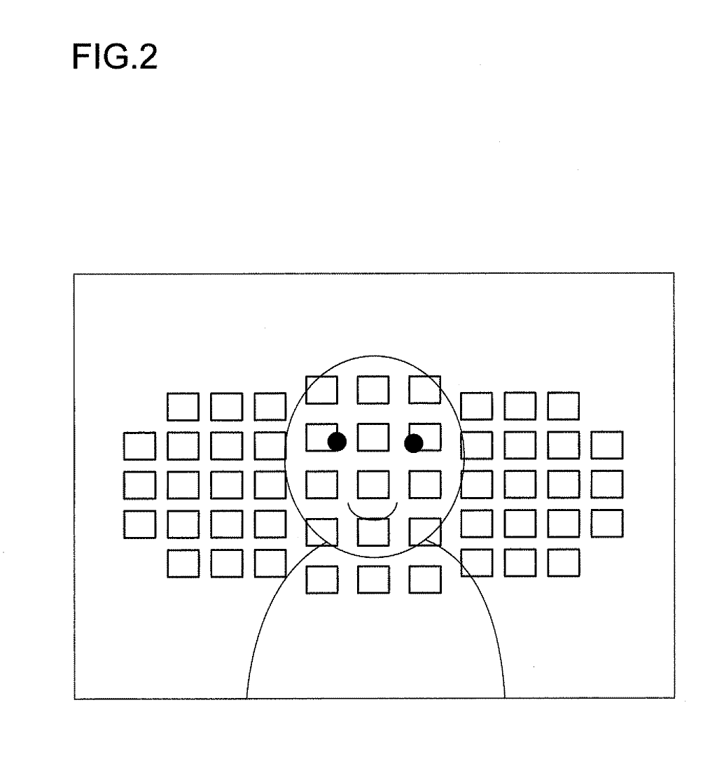

The control device 104 in the embodiment displays frames (AF frames), each in correspondence to the position at which a rangefinding sensor is disposed, by superimposing the frames on the live view image (photographic image plane) brought up on display at the monitor 106. For instance, 51 AF frames may be displayed on the photographic image plane, as shown in FIG. 2. The camera 100 achieved in the embodiment executes focus adjustment based upon rangefinding information provided via the rangefinding sensor corresponding to an AF frame, among the 51 AF frames, selected by the control device 104 through AF processing of the known art or an AF frame, among the 51 AF frames, specified by the user.

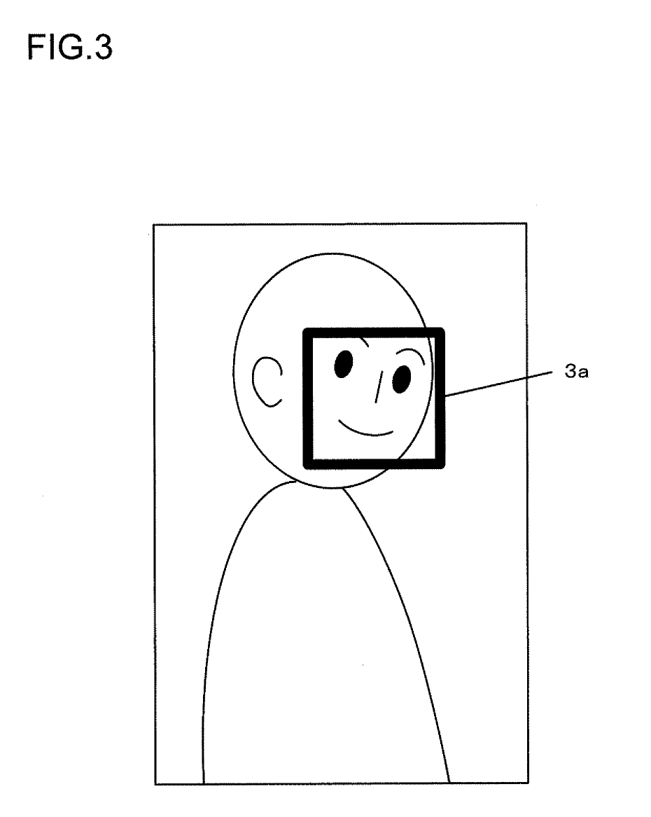

In addition, the camera 100 achieved in the embodiment has a face detection function that allows the control device 104 to detect a person's face present within the photographic image plane through face detection processing of the known art executed for an image within the photographic image plane. The control device 104 provides the results of face detection to the user by, for instance, displaying a face detection frame 3a enclosing an area containing the detected face over the live view image, as shown in FIG. 3. In addition, the control device 104 is able to track the subject while the live view image is up on display by tracking the detected face from one frame to the next or execute focus adjustment by automatically selecting an AF frame at a position near the detected face.

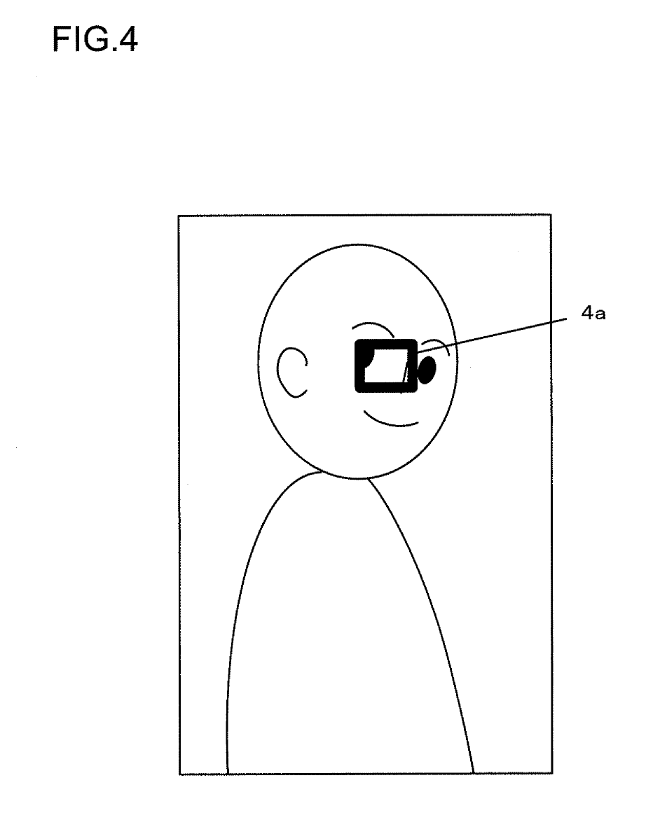

Detection of a face within the photographic image plane is normally executed by extracting characteristic facial features, such as the eyes and the mouth, from the photographic image plane and making a decision based upon the positional relationship between the characteristic features as to whether or not the characteristic features represents a person's face. When AF frames are displayed over the photographic image plane as in the case with the camera 100 achieved in the embodiment, however, the position of a characteristic feature, e.g., an eye or the mouth of a person, may overlap the position at which an AF frame 4a is displayed, as shown in FIG. 4. Under such circumstances, the control device 104 may not be able to detect the characteristic facial feature and thus may not be able to reliably detect the person's face. This issue may be addressed by adopting the means described below.

It is to be noted that the processing described below is executed by the control device 104 functioning as an image processing device in conformance to an image processing program recorded in, for instance, the flash memory in the control device 104. The processing described below is executed on an image within the photographic image plane having been designated as a face detection image and having been recorded into the buffer memory, without affecting the live view image up on display at the monitor 106. In other words, while the processing is underway, the photographic image plane, with the AF frames displayed thereupon as shown in FIG. 2, remains on display at the monitor 106.

The control device 104 erases all the AF frames 4a in the face detection image by replacing each pixel occupying a position where a frame line defining an AF frame 4a is present with an adjacent pixel, so as to generate, through interpolation, pixel data for the pixels obscured by the AF frames 4a. It is to be noted that since the AF frames 4a are set at predetermined positions within the photographic image plane as shown in FIG. 2, the control device 104 is able to determine the exact positions of the AF 4a frames within the face detection image based upon position information indicating the positions of the AF frames 4a in the photographic image plane, recorded in advance in, for instance, the flash memory.

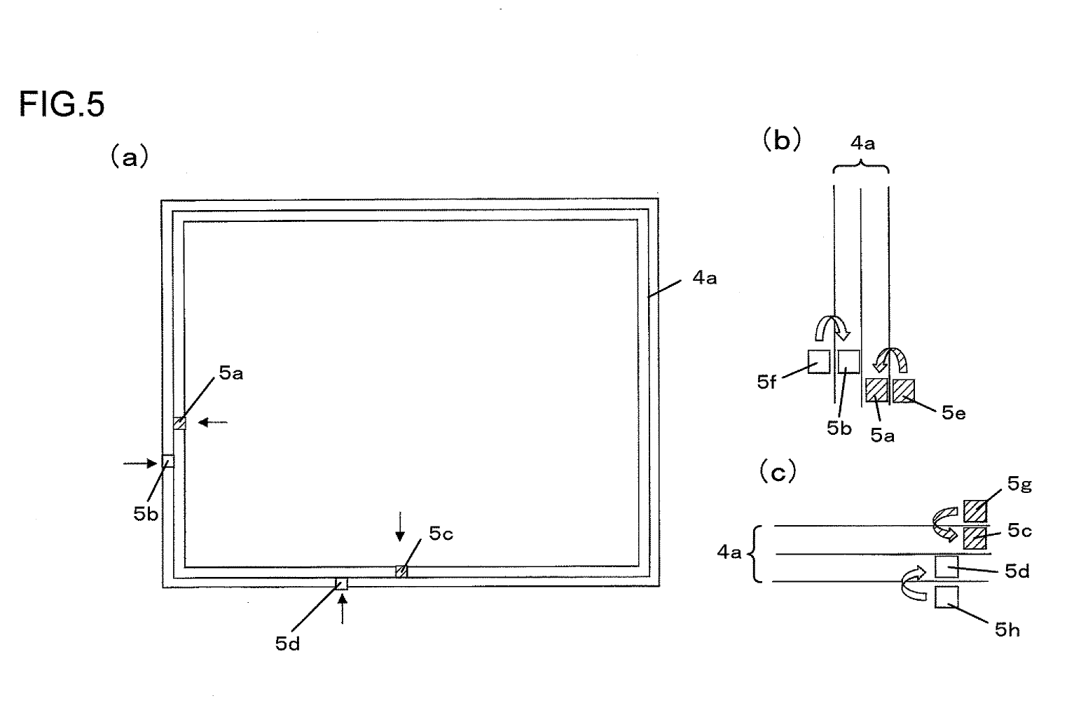

The processing executed in the embodiment is described by assuming that the width of the frame lines defining the AF frames 4a is equal to two pixels and that each AF frame 4a is defined by the vertical frame lines each made up with pixels 5a and 5b and horizontal frame lines each made up with pixels 5c and 5d, as shown in FIG. 5(a).

The control device 104 replaces the pixels 5a and 5b forming a vertical frame line, as illustrated in FIG. 5(b). Namely, the control device 104 replaces each pixel 5a with a pixel 5e located immediately to the right relative to the particular pixel 5a and replaces each pixel 5b with a pixel 5f located immediately to the left relative to the pixel 5b In addition, the control device 104 replaces the pixels 5c and 5d forming a horizontal frame line, as illustrated in FIG. 5(c). Namely, the control device 104 replaces each pixel 5c with a pixel 5g located immediately above the particular pixel 5c and replaces each pixel 5d with a pixel 5h located immediately below the pixel 5d.

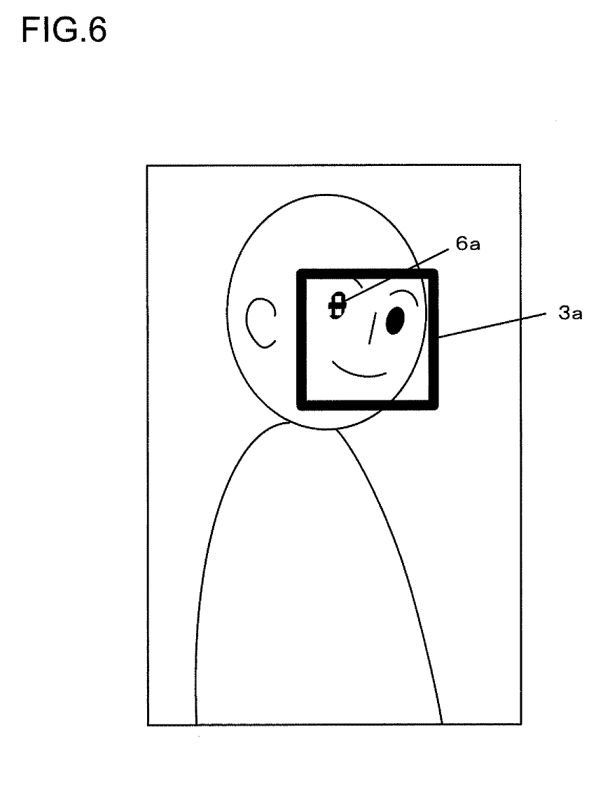

Thus, even when an AF frame 4a overlaps a person's eye, as shown in FIG. 4, the AF frame 4a is erased by using the pixel data at adjacent pixels, as shown in FIG. 6, through the processing described above. In other words, the pixel data for an eye area 6a, initially obscured or hidden by the AF frame 4a, can be generated through interpolation. As a result, the control device 104 is able to detect the person's face through the face detection processing and display the detection frame 3a over the live view image.

The control device 104 needs to be able to ascertain the exact positions of the AF frames 4a within the face detection image in order to be able to erase the AF frames 4a through the method described above. In the method described above, the position information indicating the positions of the AF frames 4a in the photographic image plane is recorded in advance in, for instance, the flash memory, so as to enable the control device 104 to determine the specific positions of the AF frames 4a in the face detection image.

However, it cannot be guaranteed that the positions of the AF frames 4a within the photographic image plane will always remain completely unchanged. For instance, the positions of the AF frames 4a within the photographic image plane may become offset through mechanical or optical causes. Under such circumstances, the accuracy of interpolation processing, executed to generate pixel data through interpolation by erasing the AF frames 4a based upon the position information indicating the positions of the AF frames 4a having been recorded in advance, may be lowered.

As a solution to this problem, an image of an AF frame 4a may be recorded in advance in the flash memory and the position of each AF frame 4a in the photographic image plane may be detected through template matching executed for an image within the photographic image plane by using the image of the AF frame 4a as a template. However, this method, too, is not without problems. Namely, in the template matching operation executed by adopting the cross correlation algorithm or the sequential similarity detection algorithm in the related art, signal intensity levels are calculated for each calculation target signal at a specific position and the template signal at the corresponding position and the signal intensity level calculation results are tabulated or added up for the overall signal. In this situation, the accuracy of the template matching operation executed in conjunction with fixed marks such as the AF frames 4a may become lowered if the target image is unclear, e.g., if the level of brightness or the level of distortion in the image varies significantly. While the matching accuracy may be improved by binarizing the matching target image and the template, it will be difficult to determine the optimal threshold value for the binarization.

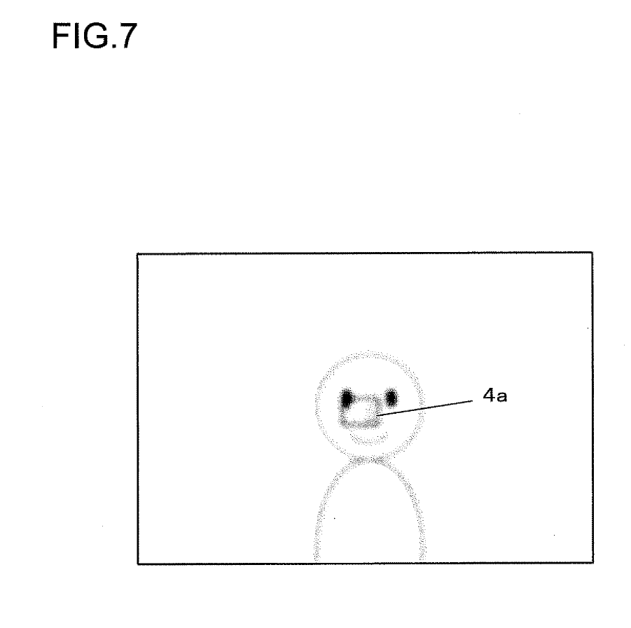

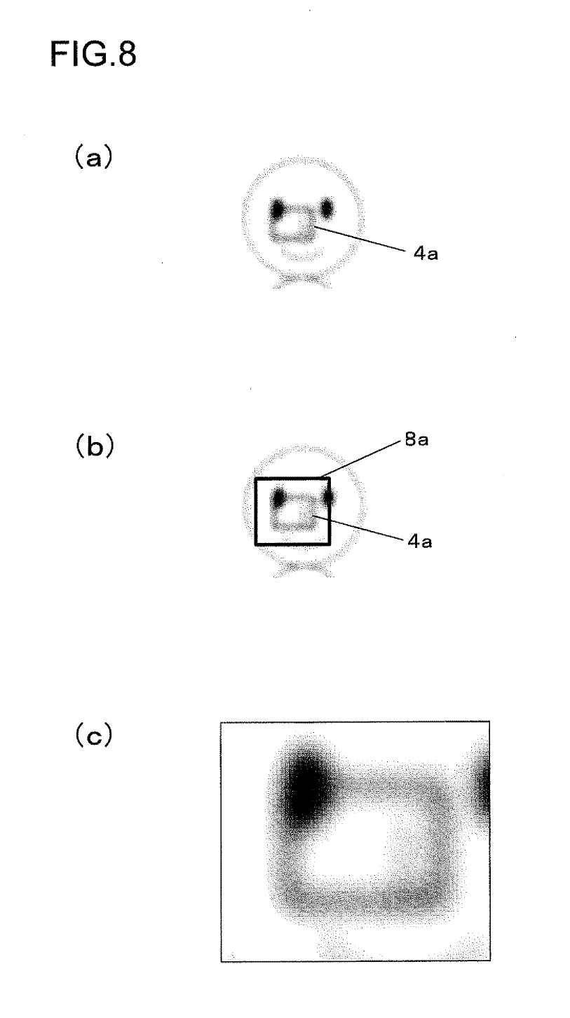

Accordingly, the control device 104 in the embodiment detects the position of an AF frame 4a within the photographic image plane as described below. The following description pertains to detection of the position of an AF frame 4a within the photographic image plane, executed for an unclear target image such as that shown in FIG. 7. It is to be noted that the position information indicating the positions of the AF frames 4a within the photographic image plane is recorded in advance in the flash memory or the like as explained earlier. This means that the control device 104 is able to estimate approximate positions of the AF frames 4a based upon the position information. FIG. 8(a) shows, in an enlargement, an area within the image shown in FIG. 7, containing the person's face.

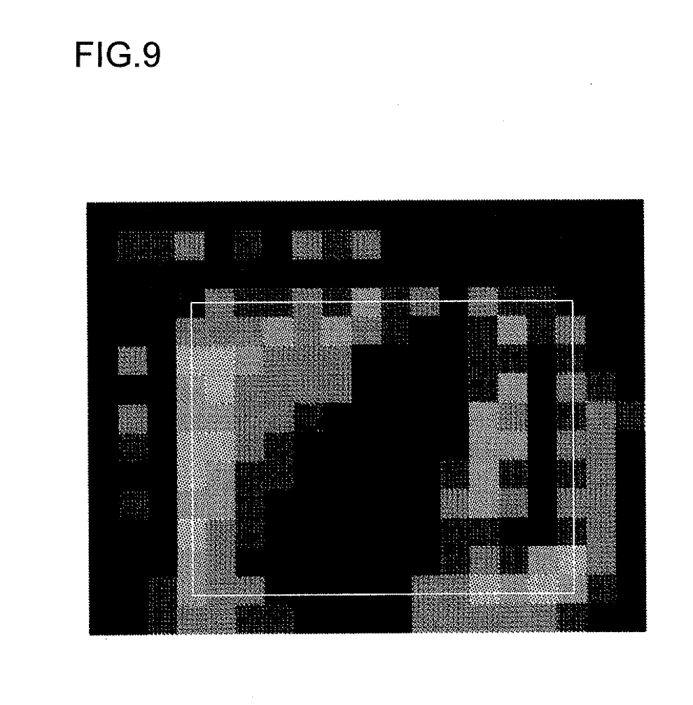

The control device 104 sets a search area 8a of a predetermined size around the estimated position of the AF frame 4a as shown in FIG. 8(b). FIG. 8(c) shows, in an enlargement, an area within the search area 8a having been set. The control device 104 then extracts edges by taking the differences between adjacent pixels in the search area 8a having been set. As a result, an edge image such as that shown in FIG. 9 is generated in correspondence to the search area 8a shown in FIG. 8(b).

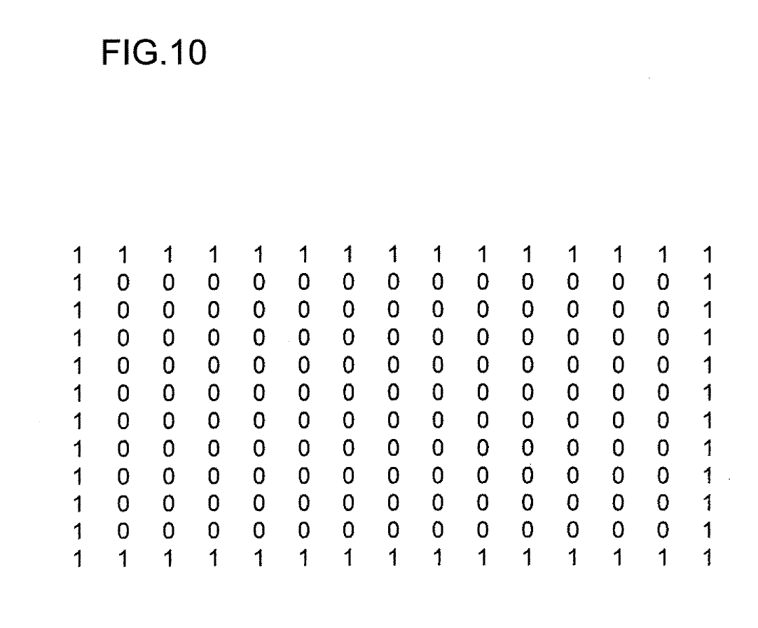

The control device 104 executes template matching for the edge image within the search area 8a having been obtained through the calculation described above, with a template prepared for determining the positions of the AF frames 4a. The template used at this time is a mask image expressing the shape of the AF frames 4a, as shown in FIG. 10, with the pixels on the outermost sides indicating 1 and the other pixels, i.e., the pixels located inward of the outermost pixels, all indicating 0. Through template matching processing executed for the edge image within the search area 8a by using this template, the specific position taken by the AF frame 4a within the search area 8a can be determined.

More specifically, the control device 104 sequentially shifts the template shown in FIG. 10 within the search area 8a. At each template position, it multiplies the pixel value indicated at each pixel expressing the template by the pixel value indicated at the corresponding pixel in the edge image occupying the position matching that of the particular pixel in the template and then calculates the grand total of the products corresponding to all the pixels expressing the template. The control device 104 uses this grand total as an evaluation value and determines that the AF frame 4a is present at the template position at which the largest evaluation value is calculated. Through this process, the control device 104 is able to determine the specific position of the AF frame 4a within the search area 8a and is ultimately able to determine the position occupied by the AF frame 4a within the photographic image plane.

The following advantages are achieved through the embodiment described above.

(1) The control device 104 erases the AF frames 4a by replacing each pixel through which a frame line defining an AF frame 4a passes with an adjacent pixel. Thus, even when an AF frame 4a is superimposed over a characteristic facial feature, face detection is enabled by erasing the AF frame 4a and generating through interpolation pixel data over the area equivalent to the eye area 6a initially obscured by the AF frame 4a.

(2) The AF frames superimposed over the photographic image plane on display indicate the positions at which the rangefinding sensors are disposed. Bearing in mind that the likelihood of a characteristic facial feature becoming obscured by information, such as the AF frames, set at fixed positions within the photographic image plane is high, information that would hinder face detection can be erased effectively.

(3) The control device 104 generates an edge image by extracting edges within the search area 8a, executes template matching operation for the edge image thus generated by using a template expressing the shape of the AF frames 4a, calculates evaluation values to be used to determine the specific position of an AF frame 4a within the photographic image plane based upon the matching results and determines the position of the AF frame 4a within the photographic image plane based upon the evaluation values. Through these measures, the position of a given AF frame 4a within the photographic image plane can be determined with a high level of accuracy even when the target image is unclear.

(4) As the control device 104 sequentially shifts the template within the search area 8a set within the photographic image plane, it multiplies the pixel value indicated at each pixel expressing the template by the pixel value indicated at the corresponding pixel in the edge image occupying the position matching that of the particular pixel in the template and calculates an evaluation value by calculating the grand total of the products corresponding to all the pixels expressing the template at each template position. Through this process, the position of the AF frame 4a within the search area 8a can be accurately determined.

(5) The control device 104 identifies the template position at which the largest evaluation value is calculated as the position of the AF frame 4a within the photographic image plane. This means that the position of a given AF frame 4a within the photographic image plane can be determined through simple processing.

### Variations

It is to be noted that the camera achieved in the embodiment described above allows for the following variations.

(1) The control device 104 in the embodiment described above detects the position of an AF frame 4a within the photographic image plane. However, the present invention is not limited to this example and the control device 104 may detect the position of a fixed pattern assuming a predetermined shape contained within the photographic image plane or within an image through the method described above in reference to the embodiment. For instance, it may detect a rectangular shape other than the AF frame 4a that is included in an image or may detect the position of an alignment mark within a wafer.

(2) In the embodiment described above, the position information indicating the positions of the AF frames 4a within the photographic image plane is recorded in advance in the flash memory or the like. Accordingly, the control device 104 in the embodiment estimates approximate positions of the AF frames 4a based upon the position information and sets the search area 8a around an estimated AF frame position. The control device 104 then executes template matching operation by generating an edge image for the image area within the search area 8a. However, if the position of a fixed pattern expressing a predetermined shape, contained within the photographic image plane or within an image, cannot be estimated, the control device 104 may generate an edge image for the entire photographic image plane or for the entire target image and may execute template matching processing for the edge image thus generated.

(3) As the control device 104 in the embodiment described above sequentially shifts the template within the search area 8a, it multiplies the pixel value indicated at each pixel expressing the template by the pixel value indicated at the corresponding pixel in the edge image occupying the position matching that of the particular pixel in the template and calculates an evaluation value by calculating the grand total of the products corresponding to all the pixels expressing the template at each template position. However, the present invention is not limited to this example and as the control device 104 sequentially shifts the template within the search area 8a, it may multiply the pixel value at each pixel expressing the template by the pixel value at the corresponding pixel in the edge image occupying the position matching that of the particular pixel expressing the template and calculate an evaluation value by calculating a product of the multiplication results corresponding to all the pixels expressing the template at each template position.

(4) The embodiment described above is achieved by adopting the present invention in the camera 100. However, the present invention is not limited to this example and may be adopted in other devices with a photographing function, such as a portable telephone equipped with a camera and a video camera.

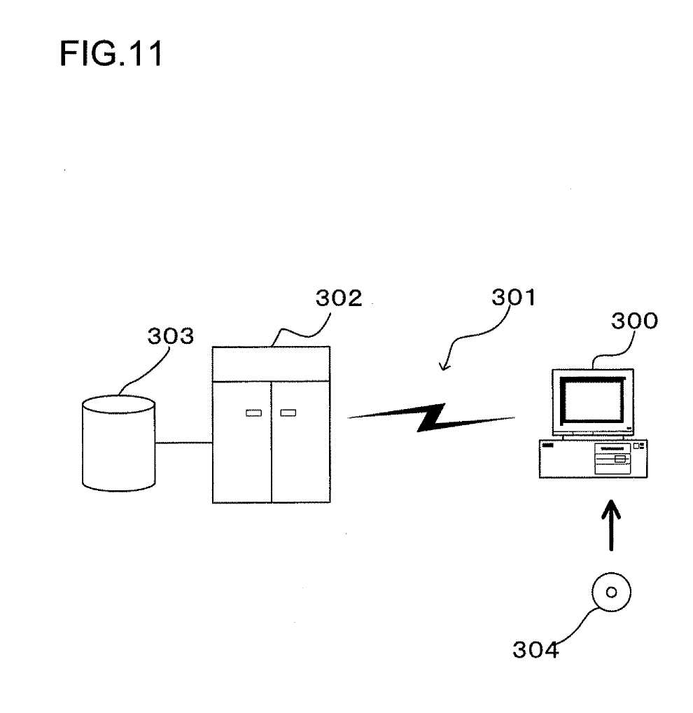

(5) In addition, when the present invention is adopted in a personal computer or the like, the image processing program enabling the control described above can be provided in a recording medium such as a CD-ROM or through a data signal transmitted via the Internet or the like. FIG. 11 shows how the image processing program may be provided. A personal computer 300 receives the program via a CD-ROM 304. In addition, the personal computer 300 has a connection capability that allows it to connect with a communication line 301. A computer 302 is a server computer that provides the program stored in a recording medium such as a hard disk 303. The communication line 301 may be a communication network such as the Internet or a personal computer communication network, or it may be a dedicated communication line. The computer 302 reads out the program from the hard disk 303 and transmits the program to the personal computer 300 via the communication line 301. Namely, the program, embodied as a data signal on a carrier wave, is transmitted via the communication line 301. In short, the program can be distributed as a computer-readable computer program product adopting any of various modes including a recording medium and a carrier wave.

As long as the features characterizing the present invention are not compromised, the present invention is not limited to any of the specific structural particulars described in reference to the embodiment. In addition, the embodiment described above may be adopted in combination with a plurality of variations.

The disclosure of the following priority application is herein incorporated by reference:

Japanese Patent Application No. 2010-170035 filed Jul. 29, 2010

1. An image processing apparatus comprising:
an edge image generation device that generates an edge image by extracting edges in an image;
a matching device that executes template matching operation for the edge image having been generated by the edge image generation device by using a template expressing a fixed pattern having a predetermined shape;
an evaluation value calculation device that calculates, based upon matching results provided by the matching device, an evaluation value to be used to determine a position of the fixed pattern having the predetermined shape within the image; and
a specifying device that specifies the position taken by the fixed pattern having the predetermined shape within the image based upon the evaluation value calculated by the evaluation value calculation device.

2. An image processing apparatus according to claim 1, wherein:
the evaluation value calculation device calculates the evaluation value at each template position taken by the template as the template is sequentially shifted within the image by multiplying a pixel value indicated at each pixel expressing the template by a pixel value indicated at a corresponding pixel in the edge image occupying a position matching the position of the pixel expressing the template and then by calculating a grand total of the multiplication results corresponding to all pixels expressing the template or by calculating a product of the multiplication results corresponding to all the pixels expressing the template used as multipliers.

3. An image processing apparatus according to claim 2, wherein:
the specifying device specifies a position taken by the template at which a largest evaluation value is calculated as the position taken within the image by the fixed pattern having the predetermined shape.

4. An image processing apparatus according to claim 1, wherein:
the fixed pattern having the predetermined shape represents an AF area set within a photographic image plane at the camera.

5. A computer-readable computer program product containing an image processing program executed by a computer, the image processing program comprising;
an edge image generation step in which an edge image is generated by extracting edges within an image;
a matching step in which template matching operation is executed for the edge image having been generated through the edge image generation step by using a template expressing a fixed pattern having a predetermined shape;
an evaluation value calculation step in which an evaluation value, to be used to determine a position taken by the fixed pattern having the predetermined shape within the image, is calculated based upon matching results obtained through the matching step; and
a specifying step in which the position taken by the fixed pattern having the predetermined shape within the image is specified based upon the evaluation value having been calculated through the evaluation value calculation step.

6. An image processing apparatus according to claim 2, wherein:
the fixed pattern having the predetermined shape represents an AF area set within a photographic image plane at the camera.

7. An image processing apparatus according to claim 3, wherein:
the fixed pattern having the predetermined shape represents an AF area set within a photographic image plane at the camera.
